(19) United States
(12) Patent Application Publication
(10) Pub. No.: US 2024/0020377 A1
(43) Pub. Date: Jan. 18, 2024

(54) BUILD SYSTEM MONITORING FOR DETECTING ABNORMAL OPERATIONS

(71) Applicant: VMware, Inc., Palo Alto, CA (US)

(72) Inventor: Shawn R. HARTSOCK, Chapel Hill, NC (US)

(21) Appl. No.: 17/812,337

(22) Filed: Jul. 13, 2022

(51) Int. Cl. G06F 21/52

(52) U.S. Cl. CPC G06F 21/52; G06F 2221/033

(57) ABSTRACT

Disclosed herein is a system and method for determining whether a system build is being interfered with by a suspicious process running during the system build. An agent captures the cache access timing pattern during the system build and asks a neural network to determine whether the cache access timing pattern for the build is similar to cache access timing patterns of other previous system builds on which the neural network is trained. The neural network generates a score that quantifies the similarity. If the score indicates too great a non-similarity, the system build is declared abnormal.

### BACKGROUND

A build system is a computing environment running a process (e.g., build script, program, executable, etc.) that takes an input (e.g., code, such as source code) and outputs a deployable software (e.g., process). Such generation of deployable software by the build system may be referred to as a build job or build of the software using the build system. For example, a build system may include a physical computing system or virtual computing instance (VCI) executing in a physical computing system running a build script that generates deployable software based on input source code. An example of a VCI includes a virtual machine (VM), container, etc. In some cases, build systems are non-deterministic, which means that two executions of the same build script and identical input produce different outputs. That is, there is no definitive output of a build system for a given input.

A malicious actor may try to compromise a build system by running other processes on a build system. In some cases, the other unwanted processes may be running on a build system accidentally. The other processes may affect the running of the build script, generating output software that is compromised. For example, the generated output software may have unwanted behavior, which can be a vector for an attack on a device that runs the generated output software. Accordingly, verifying whether a build system is operating normally or abnormally is beneficial to help ensure whether generated output software is likely to operate as intended or is potentially compromised. For example, it is desirable to determine whether unwanted processes are present in the build system.

It should be noted that the information included in the Background section herein is simply meant to provide a reference for the discussion of certain embodiments in the Detailed Description. None of the information included in this Background should be considered as an admission of prior art.

### SUMMARY

Embodiments provide a method for detecting an abnormal system build. The method includes capturing during a system build a record of cache access timing during the system build, applying the record of cache access timing and identifiers of files related to the system build to a machine learning model, where the machine learning model is trained based on records of cache access timing and identifiers of files of one or more previous system builds, obtaining from the machine learning model a score indicating similarity of the record of cache access timing with records of cache access timing of the one or more previous system builds on which the machine learning model was trained, identifying whether the system build is abnormal or normal based on whether the score indicates a similarity less than a threshold.

Further embodiments include a computer-readable medium containing instructions that, when executed by a computing device, cause the computing device to carry out one more aspects of the above method and a system comprising a memory and a processor configured to carry out one or more aspects of the above method.

### BRIEF DESCRIPTION OF THE DRAWINGS

FIG. 1 depicts a block diagram of a computer system that is representative of a virtualized computer architecture, according to embodiments.

FIG. 2A depicts in more detail the host computer system, according to embodiments.

FIG. 2B depicts a host computer system with several virtual machines, one of which has processes P1, P2, and P3 running therein, according to embodiments.

FIG. 3 depicts an example cache system.

FIG. 4 depicts a machine learning model with timing data and build system output, according to embodiments.

FIG. 5 depicts a flow of operations among an agent, an orchestrator, and a neural net, in an embodiment.

FIG. 6 depicts a flow of operations for the agent, according to embodiments.

FIG. 7 depicts a flow of operations for an orchestrator, according to embodiments.

FIG. 8 depicts a flow of operations for the machine learning net, according to embodiments.

### DETAILED DESCRIPTION

Embodiments of systems and methods are described herein for determining whether a build system is operating normally or abnormally. For example, certain aspects provide techniques for determining whether an instance of a build of software (also referred to as a build job or system build) on the build system exhibits abnormal behavior or not. Where the build exhibits abnormal behavior, the build system may be compromised, such as running a malicious process. Though certain embodiments are discussed herein with respect to a virtual machine as a build system, it should be noted that the techniques herein may be applicable to any suitable build system, such as running on a physical computing device or a VCI.

In certain embodiments, cache access timing patterns (also referred to as cache timing activity) of the build system are monitored while running a build job. For example, the cache access timing pattern includes information regarding access to one or more caches of one or more processors while a build job is running. In particular, cache access timing information includes a record of time for each cache access (e.g., a cache line or portion thereof) using a program outfitted with high-resolution timing instruments. The processors may be physical processors or virtual processors backed by physical processors. In certain embodiments, the cache access timing pattern includes timing for each cache access made while the build job is running. In certain embodiments, the cache access timing pattern includes information for a subset of the cache accesses made while the build job is running, such as periodically (e.g., every minute, hour, etc.). In certain embodiments, the cache access timing information includes one or more of: a time the access is made (e.g., a time relative to the start of the build), an identifier of the cache accessed, an identifier of the cache line accessed, and a type of access (e.g., read, write, etc.).

In certain embodiments, as part of building a training data set, the build system runs build jobs with the same input multiple times and creates a cache access timing pattern for each run of the build job with the same input. The cache access timing pattern for each run may differ from one another even with the same input for each run, as the build system may be non-deterministic, as discussed. While running the build system to build the training data set, it may be assumed that the build system is operating “normally” even though it may not be possible to strictly ensure the build system is operating as intended. Accordingly, as discussed further herein, a model trained on the training data set may be configured to determine any operation of the build system that is similar to the operation during the building of the training data set is normal. Any operation of the build system that is not similar to the operation during the building of the training data set is abnormal.

In certain embodiments, the input to the model further correlates each of the cache access timing patterns with the input and/or output of the build system during the build that is associated with the cache access pattern. For example, the training data set may include multiple sets of multiple cache access patterns, each set associated with a different input to the build system, such that the machine learning model is trained to detect an abnormal build for more than just a single input to the build system. Though certain embodiments are discussed herein with respect to a neural network, it should be noted that the techniques herein may use any suitable machine learning model.

In certain embodiments, after the machine learning model is trained, it is used to check for abnormal behavior in the build system. For example, during a build job running on the build system, the cache access timing pattern of the build system is recorded/collected. The cache access timing pattern (e.g., correlated with the input and/or output of the build system) is then input to the machine learning model, which outputs “normal” if the build was similar to the previous operation or “abnormal” if the cache access timing pattern of the build was not similar to the cache access timing patterns of previous builds. For example, in certain embodiments, if the machine learning model reports a score indicating a similarity that is lower than a given threshold, the build is abnormal. Otherwise, the build is normal.

The techniques described herein provide an improvement to the functioning of computing devices by improving the security of such computing devices. In particular, the techniques herein help protect against malicious behavior on a computing device when an unwanted process running on the computing performs a type of attack. The type of attack includes patching a file in place in the file system, changing the input byte stream sequence to the compiler in the build system, renaming files, or swapping the content of two files used in the build system. The malicious actor is thus attempting to compromise downstream systems by getting the system to accept altered outputs as trusted outputs. The malicious actor introduces the possibility of attacks of vulnerabilities, which it introduced, by other exploits such as denial of service, confused deputy exploit in which a more privileged computer system is tricked by another program or ransomware, and/or the like. In effect, the malicious actor has inserted itself into a trusted stage of the software supply chain without being noticed.

Further, the techniques described herein provide a technical solution to the technical problem of ensuring the normal operation of a computing device when performing a build for a non-deterministic system by being able to detect an abnormal operation, even in a non-deterministic system.

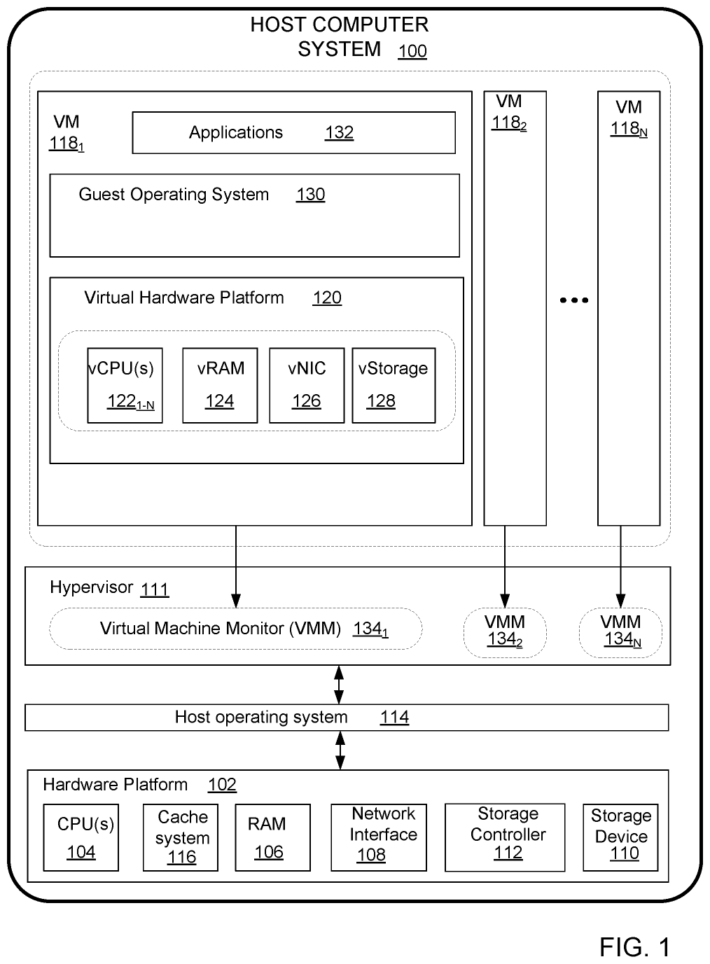

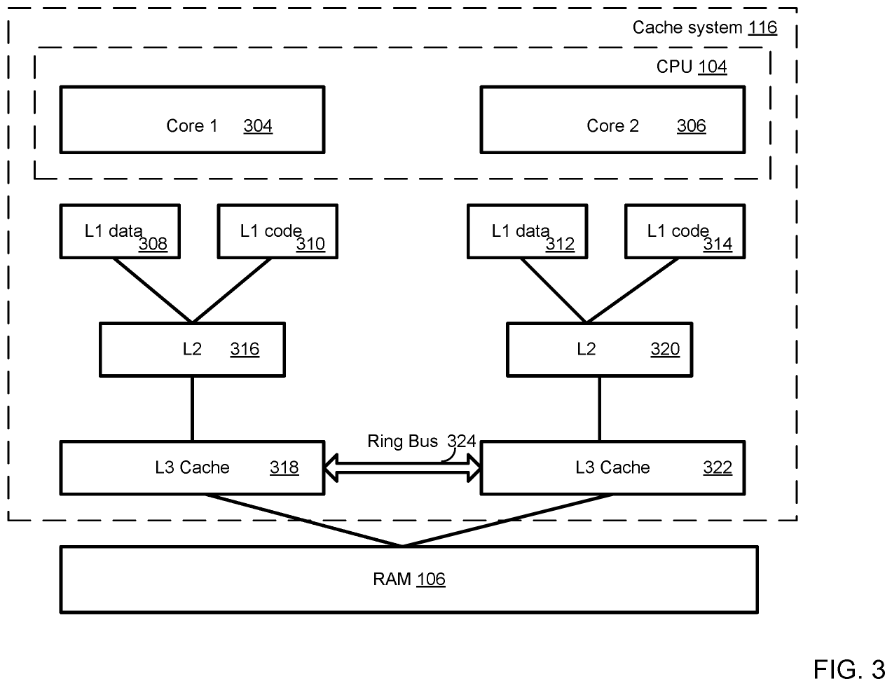

FIG. 1 depicts a block diagram of a host computer system 100 that is representative of a virtualized computer architecture. As is illustrated, host computer system 100 supports multiple virtual machines (VMs) 118₁-118_{N}, which are an example of virtual computing instances that run on and share a common hardware platform 102. Hardware platform 102 includes conventional computer hardware components, such as random access memory (RAM) 106, one or more network interfaces 108, storage controller 112, persistent storage device 110, one or more central processing units (CPUs) 104, and a cache system 116 for CPUs 104. CPUs 104 may include processing units having multiple cores. Cache system 116 is a hierarchy of caches between processing units 104 and RAM 106. Cache system 116 is further described in reference to FIG. 3.

A virtualization software layer, hereinafter referred to as a hypervisor 111, is installed on top of a host operating system 114, which itself runs on hardware platform 102. Hypervisor 111 makes possible the concurrent instantiation and execution of one or more virtual computing instances such as VMs 118₁-118_{N}. The interaction of a VM 118 with hypervisor 111 is facilitated by the virtual machine monitors (VMMs) 134₁-134_{N}. Each VMM 134₁-134_{N} is assigned to and monitors a corresponding VM 118₁-118_{N}. In one embodiment, hypervisor 111 may be a VMkernel™, which is implemented as a commercial product available from VMware™ Inc. of Palo Alto, CA. In such an embodiment, hypervisor 111 operates above an abstraction level provided by the host operating system 114.

After instantiation, each VM 118₁-118_{N} encapsulates a virtual hardware platform 120 that is executed under the control of hypervisor 111. Virtual hardware platform 120 of VM 118₁, for example, includes but is not limited to such virtual devices as one or more virtual CPUs (vCPUs) 122₁-122_{N}, a virtual random access memory (vRAM) 124, a virtual network interface adapter (vNIC) 126, and virtual storage (vStorage) 128. Virtual hardware platform 120 supports the installation of a guest operating system (guest OS) 130, which is capable of executing applications 132. Examples of guest OS 130 include any of the well-known operating systems, such as the Microsoft Windows™ operating system, the Linux™ operating system, MAC OS, and the like.

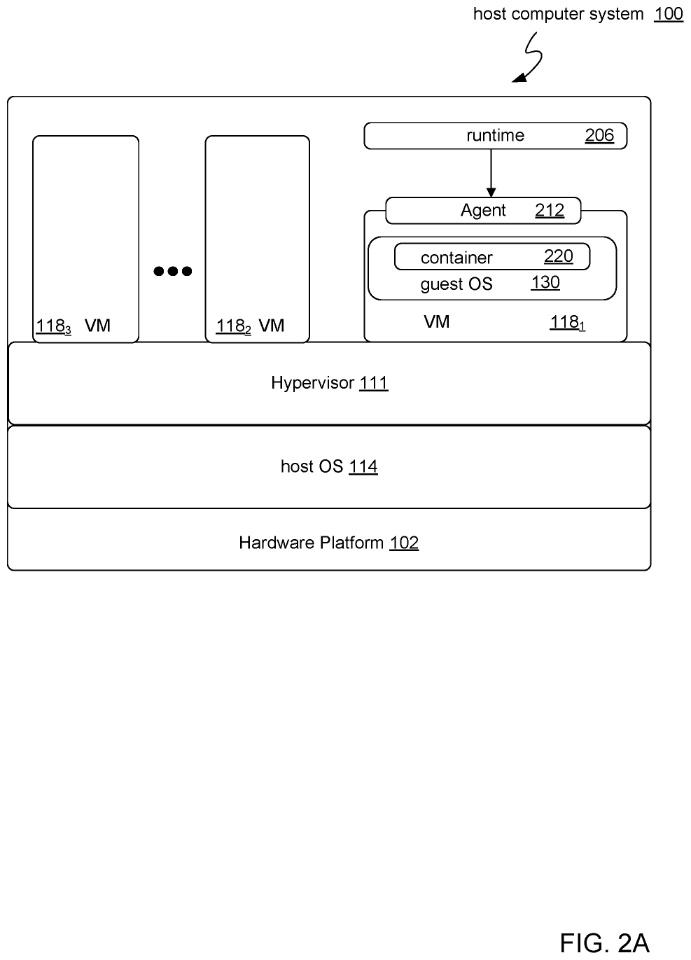

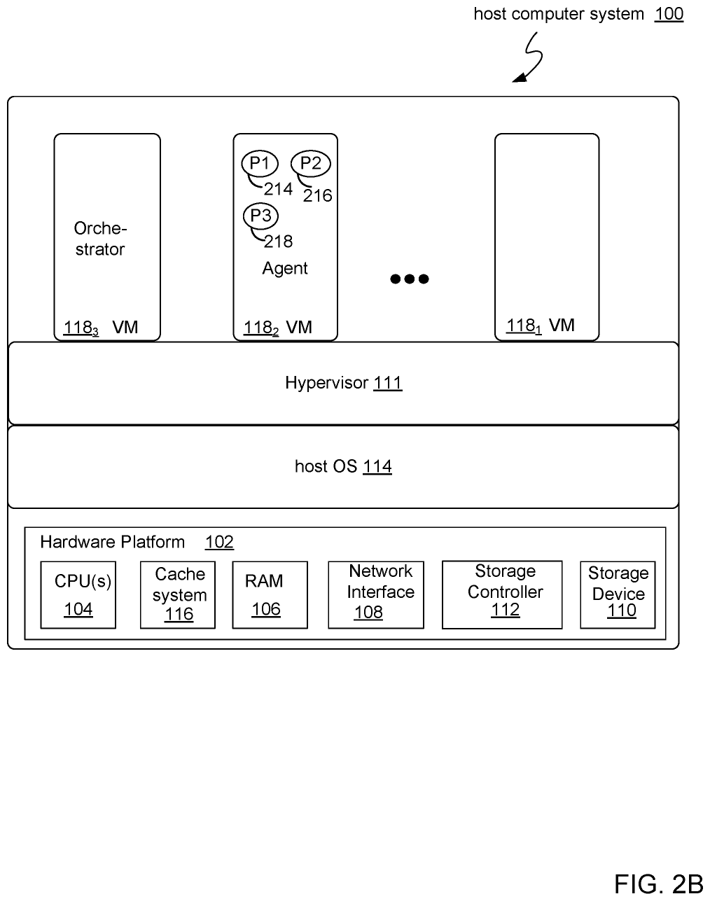

FIG. 2A depicts a configuration for running a container in a virtual machine 118₁ that runs on a host computer system 100, in an embodiment. In the configuration depicted, host computer system 100 includes hardware platform 102 and hypervisor 111, which runs a virtual machine 118₁, which runs a guest operating system 130, such as the Linux® operating system. Virtual machine 118₁ has an interface agent 212 that is coupled to a runtime 206, running on the host operating system 114. In one embodiment, virtual machine 118₁ is a light-weight VM that is customized to run containers.

Container runtime 206 is the process that manages the life cycle of container 220. In particular, container runtime 206 fetches a container image. In some embodiments, container runtime 206 is a Docker® container.

FIG. 2B depicts a host computer system with several virtual machines, one of which has processes P1 214, P2 216, and P3 218 running therein, according to embodiments. Process P1 214 executes a script that performs the system build. Process P2 216 monitors the cache activity of cache system 116 in hardware platform 102 during the system build. Process P3 218 is a process that should not be present during the build and is thus unwanted.

As mentioned above, hardware platform 102 includes a cache system. FIG. 3 depicts an example cache system 116.

Processing units with fast clocks use caches to have quick access to needed data. However, caches with quick access are too small to capture the working set of the processor when executing a process. Therefore, a cache hierarchy is set up, in which the hierarchy includes slower levels but larger caches providing data to faster higher levels.

The caches closest to the processor are called the L1 data cache 308, 312 and L1 code cache 310, 314. The caches lower in the hierarchy are called L2 cache 316, 320, and L3 cache 318, 322, with the L3 cache 318, 322 being closest to main memory. L3 cache 318, 322 is usually very large and is shared among multiple processors or processor cores. The example depicts a ring bus 324 that connects portions of L3 cache 318, 322 to form a very large cache.

L3 cache 318, 322 obtains data from RAM 106, which is very large and slow in comparison to L3 cache 318, 322. A physical address is needed to access data from main memory. The physical address is derived from page tables which translate a virtual address used by the process to the physical address. The most recently used translations are stored in a translation look aside buffer (TLB), which acts as a cache for the recently-used translations. The page tables in most computer systems permit sharing of memory data among processes by mapping different virtual addresses to the same physical address. Sharing of memory data also means that data in L3 cache 318, 322 is shared among processes. This sharing causes contention among data sets in L3 cache 318, 322 because during execution, data from one process can cause the eviction of some or all of the data from another executing process.

When a process first runs on a processing unit, its execution time is substantially affected by the cache hierarchy because of the time it takes to bring data and instructions into the cache, such as the levels of the hierarchy.

Information about the specific workings of a targeted process, such as a process running a build job on a build system, can thus be obtained by monitoring the execution of the process during its run. A record of the timing of cache line accesses during the execution of a process can serve as a fingerprint of the process.

There are several ways to learn about the execution of a process. One way is to have the second process, say P3, in FIG. 2B, fill the cache, such as the data cache, with its own content (i.e., prime the cache). Priming can occur by calling a shared library before any other process calls the library. Next, the second process waits for a pre-specified interval during which the first process (the targeted process) runs, accessing specific lines in the cache and evicting the content of the second process. Next, the second process reads the instructions and data that the second process used to previously fill the cache and records the time of each cache access (e.g., probe the cache). Recording the time of each cache access is performed by a program outfitted with fine processing timing instruments capable of measuring times in milliseconds or nanoseconds. A similar process applies to the instruction cache. The probing step builds the “heat maps,” e.g., representing a record of the cache access timing during the probing step. In certain embodiments, the timings in this record are translated to grayscale values and plotted in a two-dimensional grid to form a pattern for the activity over time during the probing.

The information about a targeted process can be learned even while the target process runs in a virtual machine or a container.

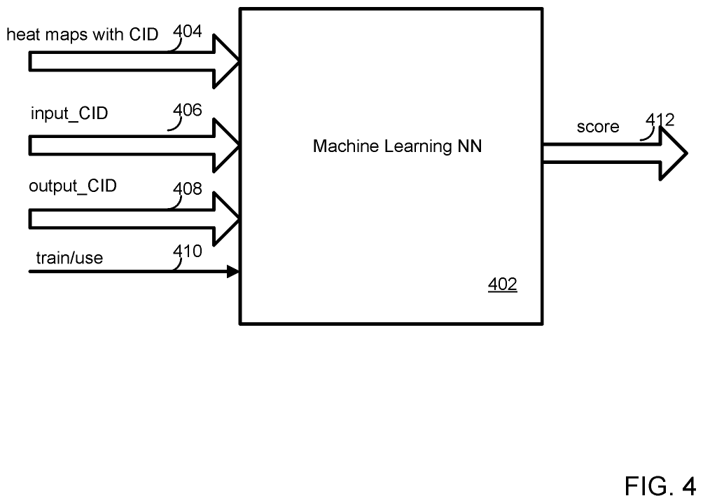

FIG. 4 depicts a machine learning model with timing data and build system output, according to embodiments. Machine learning model, such as neural network ML_NN 402, has as inputs the heat maps 404 and identifiers of files related to the build. Such identifiers of files include an input content identifier (CID) 406 and the output CID 408, where a content identifier is a unique numerical representation of the contents of a file or files, such as a hash. The output 412 of the ML_NN 402 is a score. Neural network ML_NN 402 is trained to correlate input CID 406, output CID 408, and heat maps 404 for a large number of builds. When neural network ML_NN 402 encounters heat maps 404, an input CID 406, and an output CID 408 of a system build, including a new system build, it classifies the system build according to an output score indicating similarity to the system builds it encountered during training. If a score for a particular system build is lower than a threshold, then the system build is deemed abnormal.

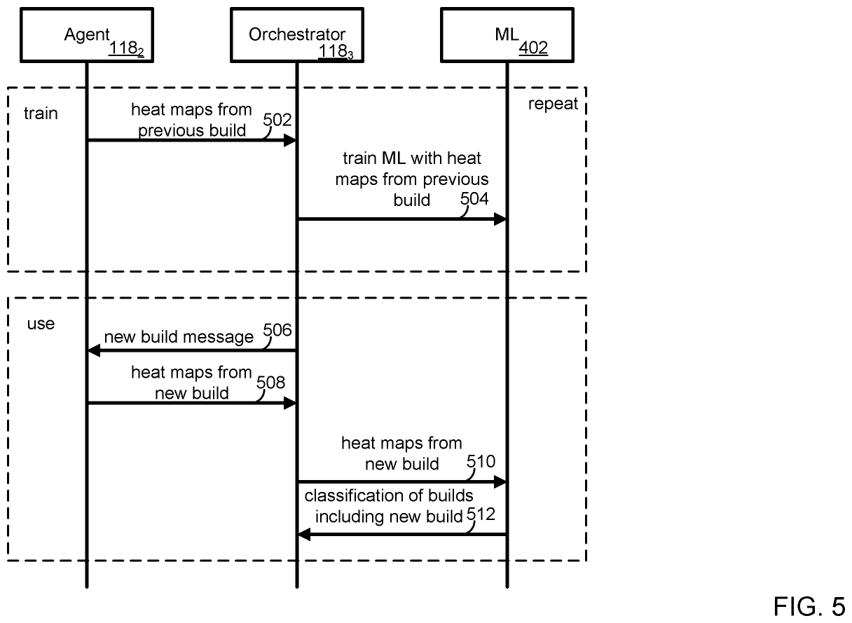

FIG. 5 depicts a flow of operations among an agent, an orchestrator, and a neural net, in an embodiment. In one phase (the training phase), agent 1182 sends heat maps 404 in step 502 from one or more previous builds to orchestrator 1183, which then sends in step 504 the heat maps 404 to the machine learning neural 402 to train the neural net. In another phase (the use phase), orchestrator 1183 sends a new build message in step 506 to agent 1182 indicating that a new build is occurring. Agent 1182 then records and sends in step 508 the heat maps 404 from the new build back to orchestrator 1183. Orchestrator 1183 then sends in step 510 the heat maps 404 from the new build to neural network ML_NN 402, which then classifies the system builds, including the new system build, as either normal or abnormal based on a score provided by the output of neural network ML_NN 402. Neural network ML_NN 402 then sends the classification back to orchestrator 1183 in step 512.

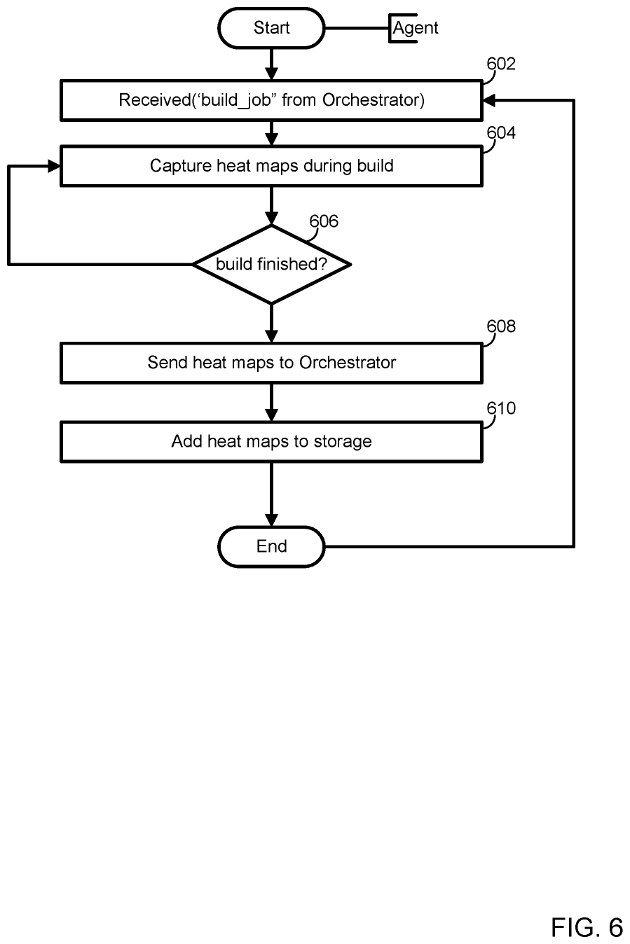

FIG. 6 depicts a flow of operations for the agent, according to embodiments. In step 602, agent 1182 receives a build job message from orchestrator 1183 indicating that a new build is underway. During the build, agent 1182 captures heat maps 404 in step 604. When the build is finished, as determined in step 606, agent 1182 sends, in step 608, the captured heat maps 404 to orchestrator 1183, and in step 610, adds the heat maps 404 to storage.

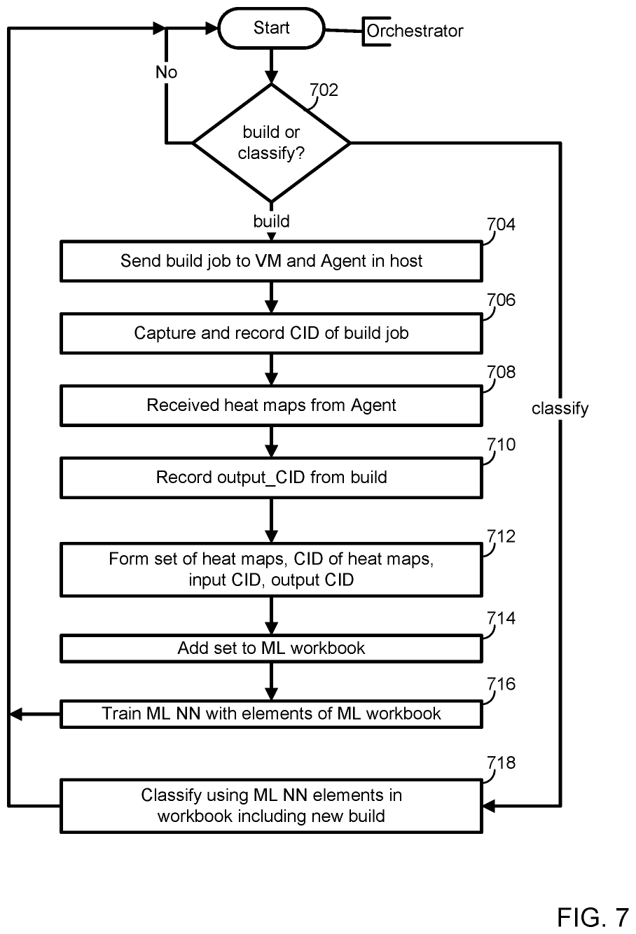

FIG. 7 depicts a flow of operations for an orchestrator, according to embodiments. In step 702, orchestrator 1183 determines whether a build or a classify operation is underway. If a build operation is occurring, then in step 704, orchestrator 1183 sends a build job message to agent 1182 in the host. In step 706, orchestrator 1183 captures and records the CID of the system build job. In step 708, orchestrator 1183 receives heat maps 404 captured during the build from agent 1182. In step 710, orchestrator 1183 records the CID for the output files of the build. In step 712, orchestrator 1183 forms a set of heat maps, the CID of the heat maps, the input CID, and the output CID. In step 714, orchestrator 1183 adds the set to the ML workbook. In step 716, orchestrator 1183 requests that ML neural network 402 be trained with the build.

If a classify operation is underway, as determined in step 702, orchestrator 1183 requests in step 718 that ML neural network 402 classify the items in the ML_workbook, including the new system build.

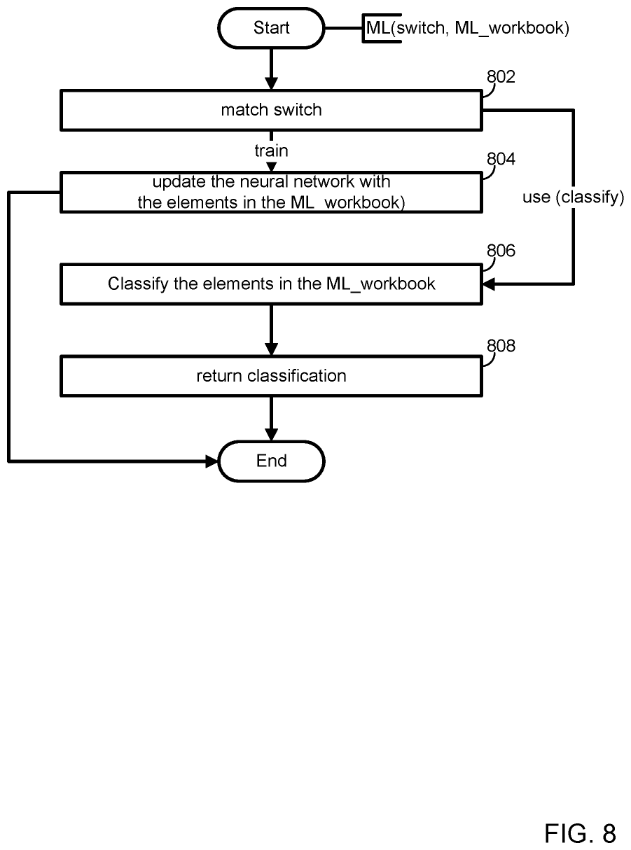

FIG. 8 depicts a flow of operations for the machine learning net, according to embodiments. In step 802, ML neural net 402 determines whether the value of the switch parameter 410 is either train or use (classify). If the parameter is ‘train,’ as determined in step 802, ML network 402 is trained in step 804 with the items in the ML workbook. If the parameter is ‘use’ (classify), then ML neural network 402 classifies in step 806 the items in the ML workbook, including any new builds, and, in step 808, returns the classification.

Thus, a neural network trained with heat maps, input CID, and output CID of previous builds can spot a build that has an anomalous heat map, which may indicate that another, unwanted process, is running during the build. Once an unwanted process running during the build is detected, the process can be killed before another attempt is made to run the build script, thereby increasing the likelihood of a normal build. In addition, the process can be examined to determine whether its parent process has been infected. Security measures are then taken to remove the infected parent.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations, including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer-readable media. The term computer-readable medium refers to any data storage device that can store data, which can thereafter be input to a computer system-computer-readable media may be based on any existing or subsequently developed technology for embodying computer programs in a manner that enables them to be read by a computer. Examples of a computer-readable medium include a hard drive, network-attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer-readable medium can also be distributed over a network-coupled computer system so that the computer-readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation unless explicitly stated in the claims.

Virtualization systems, in accordance with the various embodiments, may be implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments, as described above, involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers, each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained only to use a defined amount of resources such as CPU, memory, and I/O. The term “virtualized computing instance” as used herein is meant to encompass both VMs and OS-less containers.

Many variations, modifications, additions, and improvements are possible, regardless of the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

1. A method of detecting an abnormal system build, the method comprising:
capturing during a system build a record of cache access timing during the system build;
applying the record of cache access timing and identifiers of files related to the system build to a machine learning model, wherein the machine learning model is trained based on records of cache access timing and identifiers of files of one or more previous system builds;
obtaining from the machine learning model a score indicating similarity of the record of cache access timing with records of cache access timing of the one or more previous system builds on which the machine learning model was trained; and
identifying whether the system build is abnormal or normal based on whether the score indicates a similarity less than a threshold.

2. The method of claim 1, wherein files related to the system build include input files and the identifiers of the files include a content identifier (CID) of the input files, the CID being a hash of the input files.

3. The method of claim 1, wherein files related to the system build include output files, and the identifiers of the files include a content identifier (CID) of the output files, the CID being a hash of the output files.

4. The method of claim 1, wherein files related to the system build include input and output files and the identifiers of the files include a first content identifier (CID) of the input files and a second CID of the output files, the first CID being a hash of the input files and the second CID being a hash of the output files.

5. The method of claim 1, wherein the record of cache access timing includes timing information for cache line accesses during the system build.

6. The method of claim 5, wherein the timing information is converted into a two-dimensional image suitable as an input to the machine learning model.

7. The method of claim 1, wherein the output files of the system build are not known before the system build.

8. A system for detecting an abnormal system build, the system comprising:
one or more central processing units;
a cache system for the one or more central processing units; and
a memory into which is loaded a hypervisor and a plurality of virtual machines and a machine learning model, wherein a first virtual machine runs an orchestrator, a second virtual machine runs an agent, and a third virtual machine performs a system build;
wherein the agent is configured to capture during the system build a record of cache access timing in the cache system during the system build; and
wherein the orchestrator is configured to:
apply the record of cache access timing to the machine learning model, the machine learning model being trained based on records of cache access timing and identifiers of files of one or more previous system builds,
obtain from the machine learning model a score indicating similarity to the record of cache access timing with records of cache access timing of one or more previous system builds on which the machine learning model was trained; and
identify whether the system build is abnormal or normal based on whether the score indicates a similarity less than a threshold.

9. The system of claim 8, wherein files related to the system build include input files and the identifiers of the files include a content identifier (CID) of the input files, the CID being a hash of the input files.

10. The system of claim 8, wherein files related to the system build include output files, and the identifiers of the files include a content identifier (CID) of the output files, the CID being a hash of the output files.

11. The system of claim 8, wherein files related to the system build include input and output files and the identifiers of the files include a first content identifier (CID) of the input files and a second CID of the output files, the first CID being a hash of the input files and the second CID being a hash of the output files.

12. The system of claim 8, wherein the record of cache access timing includes timing information cache line accesses during the system build.

13. The system of claim 12, wherein the timing information is converted into a two-dimensional image suitable as an input to the machine learning model.

14. The system of claim 8, wherein the output files of the system build are not known before the build.

15. A non-transitory computer-readable medium comprising instructions, which, when executed, cause a computer system to carry out a method for detecting an abnormal system build, the method comprising:
capturing during a system build a record of cache access timing during the system build;
applying the record of cache access timing and identification files related to the build to a machine learning model, wherein the machine learning model is trained based on records of cache access timing and identifiers of files for the builds of one or more previous system builds;
obtaining from the machine learning model a score indicating similarity of the record of cache access timing with records of cache access timing of the one or more previous system builds on which the machine learning model was trained; and
identifying whether the system build is abnormal or normal based on whether the score indicates a similarity less than a threshold.

16. The non-transitory computer-readable medium of claim 15, wherein files related to the system build include input files, and the identifiers of the files include a content identifier (CID) of the input files, the CID being a hash of the input files.

17. The non-transitory computer-readable medium of claim 15, wherein files related to the system build include output files, and the identifiers of the files include a content identifier (CID) of the output files, the CID being a hash of the output files.

18. The non-transitory computer-readable medium of claim 15, wherein files related to the system build include input and output files and the identifiers of the files include a first content identifier (CID) of the input files and a second CID of the output files, the first CID being a hash of the input files and the second CID being a hash of the output files.

19. The non-transitory computer-readable medium of claim 15, wherein the record of cache access timing includes timing information regarding cache line accesses during the system build.

20. The non-transitory computer-readable medium of claim 19, wherein the timing information is converted into a two-dimensional image suitable as an input to the machine learning model.
